(19) United States
(12) Patent Application Publication
(10) Pub. No.: US 2023/0179320 A1
(43) Pub. Date: Jun. 8, 2023

(54) INDICATION ON PROBABILISTIC SHAPING

(71) Applicant: QUALCOMM Incorporated, San Diego, CA (US)

(72) Inventors: Xiaoxia ZHANG, San Diego, CA (US); Jun MA, San Diego, CA (US); Zhifei FAN, San Diego, CA (US); Tao LUO, San Diego, CA (US); Iyab Issam SAKHNINI, San Diego, CA (US); Junyi LI, Fairless Hills, PA (US); Bin TIAN, San Diego, CA (US); Jing SUN, San Diego, CA (US)

(21) Appl. No.: 17/543,432

(22) Filed: Dec. 6, 2021

(51) Int. Cl. H04L 1/00; H04W 72/04; H04W 28/06; H04L 5/00

(52) U.S. Cl. CPC H04L 1/0002; H04L 5/0044; H04W 28/06; H04W 72/0406

(57) ABSTRACT

Certain aspects of the present disclosure provide techniques for indicating actual transport block size (TBS) on shaping encoding. For example, in shaping encoding, instead of using a compensated rate code (e.g., by padding or truncating) for a fixed number of output bits that is often different from the TBS scheduled, the present disclosure supports using multiple actual TBS for a given nominal TBS to improve efficiency of the shaping encoder. A transmitter (e.g., a network entity or use equipment (UE)) may encode a payload size of bits with a shaping encoder to obtain a transport block (TB), which has an actual TBS. The actual TBS is selected from a set of TBSs based on a nominal TBS. The transmitter then transmits to a receiver, an indication of the actual TBS. The indication enables the receiver to decode the corresponding encoded bits. The transmitter then transmits the TB to the receiver.

### INTRODUCTION

Aspects of the present disclosure relate to wireless communications, and more particularly, to techniques for probabilistic shaping.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communications by a transmitter. The method includes encoding a payload size of bits with a shaping encoder to obtain a transport block (TB) having an actual TB size (TBS). The actual TBS is selected from a set of TBSs based on a nominal TBS. The method further includes transmitting, to a receiver, an indication of the actual TBS and transmitting the TB to the receiver.

One aspect provides a method for wireless communications by a receiver. The method includes receiving, from a transmitter, an indication of an actual TBS of a TB. The actual TBS is selected from a set of TBSs based on a nominal TBS. The method further comprises receiving the TB from the transmitter, and decoding the TB with a shaping decoder, based on the actual TBS.

One aspect provides an apparatus for wireless communications by a transmitter. The apparatus includes a memory and a processor coupled with the memory. The processor and the memory are configured to encode a payload size of bits with a shaping encoder to obtain a transport block (TB) having an actual TB size (TBS). The actual TBS is selected from a set of TBSs based on a nominal TBS. The processor and the memory are further configured to transmit, to a receiver, an indication of the actual TBS; and transmit the TB to the receiver.

One aspect provides non-transitory computer readable medium storing instructions that when executed by a transmitter cause the transmitter to encode a payload size of bits with a shaping encoder to obtain a transport block (TB) having an actual TB size (TBS). The actual TBS is selected from a set of TBSs based on a nominal TBS. The non-transitory computer readable medium storing instructions that further cause the transmitter to transmit, to a receiver, an indication of the actual TBS; and transmit the TB to the receiver.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 depicts an example shaping encoding process, in accordance with certain aspects of the present disclosure.

FIG. 5 depicts a call flow diagram between a transmitter and a receiver, in accordance with certain aspects of the present disclosure.

FIG. 6 depicts an example shaping decoding process, in accordance with certain aspects of the present disclosure.

FIGS. 7 and 8 show example methods for shaping encoding or decoding based on actual transport block sizes, according to aspects of the present disclosure.

FIGS. 9 and 10 show examples of communications devices according to aspects of the present disclosure.

### DETAILED DESCRIPTION

Aspects of the present disclosure provide apparatuses, methods, processing systems, and computer-readable mediums for indicating actual transport block size (TBS) on shaping encoding. For example, instead of using a compensated rate code (e.g., by padding or truncating) for a fixed number of output bits that is often different from the TBS scheduled, aspects of the present disclosure support using multiple actual TBSs for a given nominal TBS to improve efficiency of the shaping encoder.

At a high level, shaping encoding includes techniques such as probabilistic shaping or constellation shaping, e.g., a modulation format optimization method for increasing transmission capacity. Probabilistic shaping changes signal distribution at the channel input, such as the dyadic probabilistic shaping for pulse amplitude modulation (PAM). Such shaping encoding enhances energy efficiency for digital signal modulation that improves upon amplitude and phase-shift keying (APSK) and conventional quadrature amplitude modulation (QAM) by transmitting low-energy signals more frequently than high-energy signals.

A constellation refers to a pattern of signal combinations. In a static constellation, different combinations appears equally (e.g., in a QAM constellation). When transmission channel distorts signals unevenly, different combinations require different levels of energy and have different levels of noises. Thus, a shaped constellation transmission may send certain combinations more often than others for optimizing signal quality (e.g., achieving the same level of signal quality with reduced energy, or maintain the same energy while achieving improved signal quality). Probabilistic shaping may be used to shape the constellation to affect such optimization and increase the transmission capacity (e.g., by 15-43% on 16-QAM channel)..

Existing shaping encoders often use a fixed number of output bits, which are later compensated (e.g., padded or truncated). Such practice lowers the operation efficiency, due to a mismatch between a fixed number of output bits and a variable actual transport size (TBS). The actual TBS depends on a specific number of bits in the payload. When the shaping encoder maps a variable number of input bits to a fixed number of output bits, and the fixed number of output bits is not the same as the actual TBS, the encoder output will be padded or truncated to meet the predetermined (e.g., original) payload size, which is an inefficient use of resources.

Aspects of the present disclosure, however utilize a variable number of output bits that correspond to the actual TBS, which may lead to more efficient resource usage. For example, instead of using one pre-determined actual TBS based on the original or nominal payload size, multiple actual TB sizes are used for a given nominal TBS to improve the shaping encoder efficiency. Other examples and implementations are discussed below.

### Introduction to Wireless Communication Networks

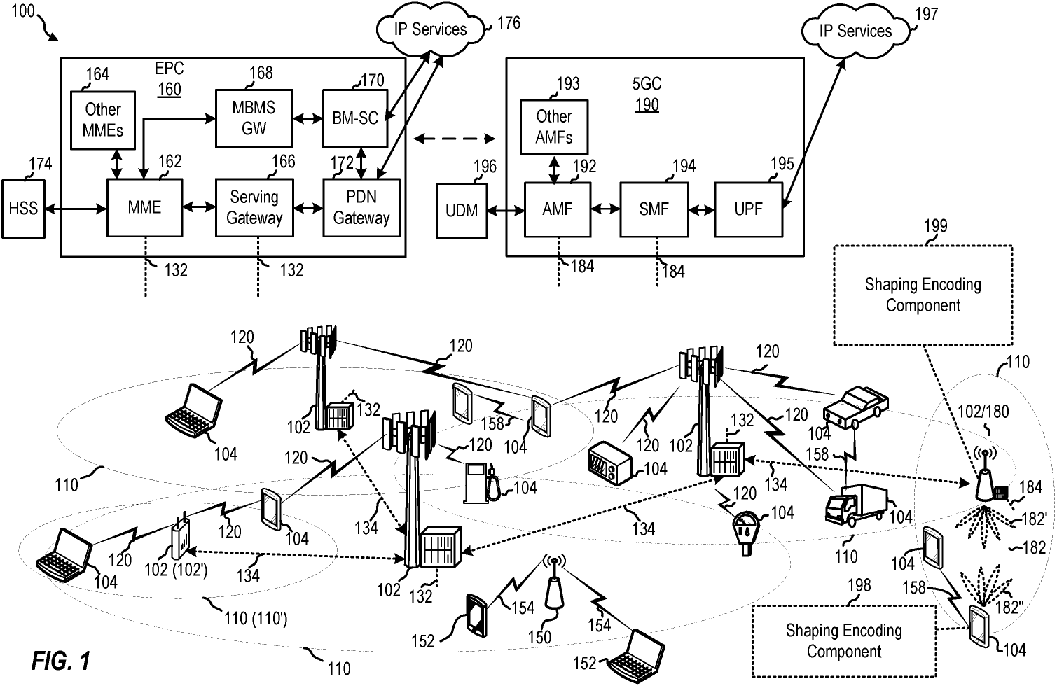

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

A base station, such as BS 102, may include components that are located at a single physical location or components located at various physical locations. In examples in which the base station includes components that are located at various physical locations, the various components may each perform various functions such that, collectively, the various components achieve functionality that is similar to a base station that is located at a single physical location. As such, a base station may equivalently refer to a standalone base station or a base station including components that are located at various physical locations or virtualized locations. In some implementations, a base station including components that are located at various physical locations may be referred to as or may be associated with a disaggregated radio access network (RAN) architecture, such as an Open RAN (O-RAN) or Virtualized RAN (VRAN) architecture. In some implementations, such components of a base station may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes shaping encoding component 199, which may be configured to process transmissions based on TCI states mapped to TCI codepoints indicated Wireless network 100 further includes shaping encoding component 198, which may be used configured to perform downlink and uplink panel switching according to indicated TCI states.

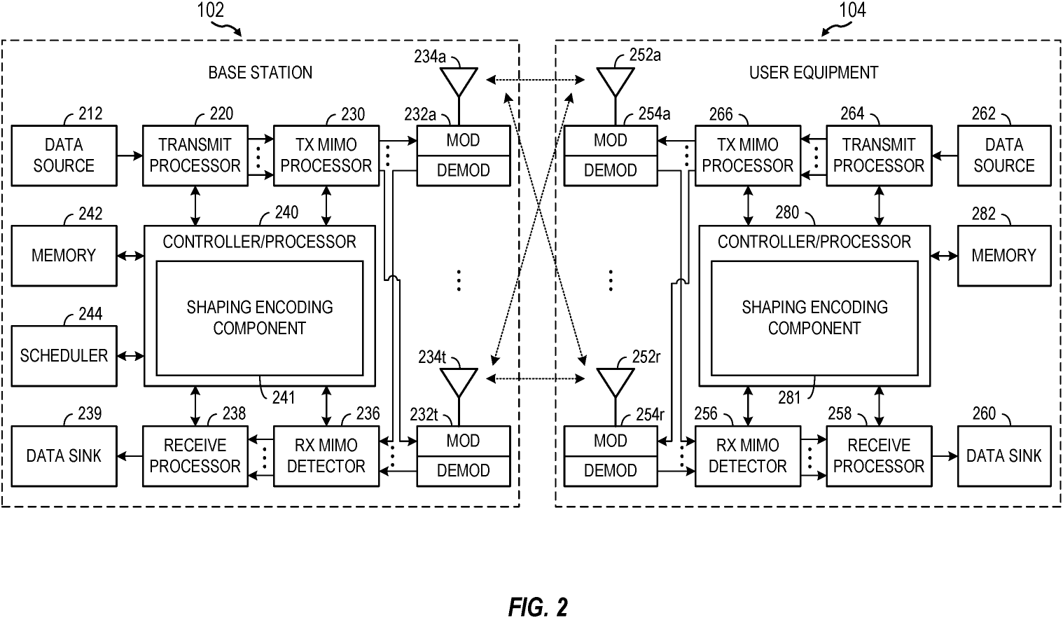

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller / processor 240, which may be configured to implement various functions related to wireless communications. In the depicted example, controller / processor 240 includes shaping encoding component 241, which may be representative of shaping encoding component 199 of FIG. 1. Notably, while depicted as an aspect of controller / processor 240, shaping encoding component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller / processor 280, which may be configured to implement various functions related to wireless communications. In the depicted example, controller / processor 280 includes shaping encoding component 281, which may be representative of shaping encoding component 198 of FIG. 1. Notably, while depicted as an aspect of controller / processor 280, shaping encoding component 281 may be implemented additionally or alternatively in various other aspects of UE 104 in other implementations.

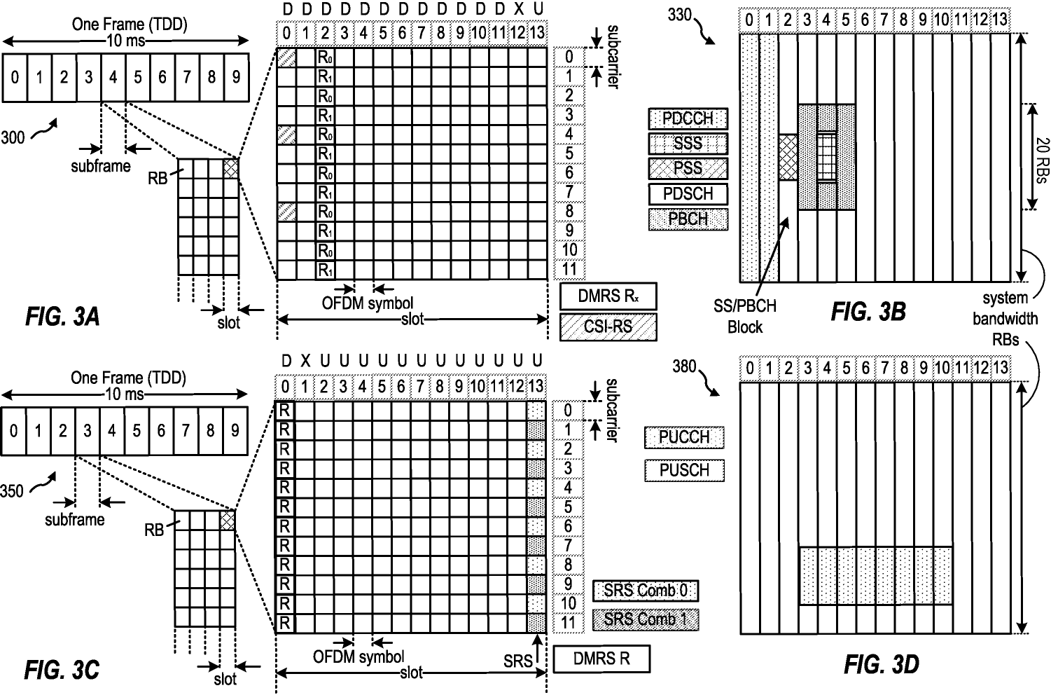

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

### Introduction to mmWave Wireless Communications

In wireless communications, an electromagnetic spectrum is often subdivided, into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHz - 6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26 - 41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz - 300 GHz) that is identified by the International Telecommunications Union (ITU) as a “millimeter wave” band because wavelengths at these frequencies are between 1 millimeter and 10 millimeters.

Communications using the mmWave / near mmWave radio frequency band (e.g., 3 GHz - 300 GHz) may have higher path loss and a shorter range compared to lower frequency communications. Accordingly, in FIG. 1, mmWave base station 180 may utilize beamforming 182 with the UE 104 to improve path loss and range. To do so, base station 180 and the UE 104 may each include a plurality of antennas, such as antenna elements, antenna panels, and/or antenna arrays to facilitate the beamforming. Therefore, multiple transmission reception points (multi-TRPs) or communications via multiple radio access links using the plurality of antennas or panels may be used to counteract path loss or otherwise to improve channel reliability.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Further, as described herein, UEs of mmW communications may benefit from improved efficiency in shaping encoding, as described in details below.

### Example Modulation and Probabilistic Shaping

Constellation shaping is a method of energy efficiency enhancement for digital signal modulation. In information theory, an optimum constellation (e.g., to achieve an optimal signal-to-noise ratio (SNR)) may include a two dimensional (2D) Gaussian distribution for a constellation probability. As an example, amplitude and phase-shift keying (APSK) conveys data by modulating the amplitude and the phase of a carrier wave, to achieve a lower bit error rate for a given modulation order and SNR. Quadrature amplitude modulation (QAM) may be considered as a type of APSK modulation scheme (as QAM modulates both the amplitude and phase of the carrier). Normally in a QAM constellation, each value is used with equal probability. Non-uniform spacing within a QAM constellation is one way to approximate 2D Gaussian distribution at the cost of increased demodulation.

Probabilistic shaping of the constellation is another way to control the probability of each modulation value to approximate a 2D Gaussian distribution, using a uniformly spaced constellation. Implementing probabilistic shaping requires a shaping encoder at the transmitter prior to modulation and a shaping decoder at the receiver after modulation. Currently most shaping encoders use variable rate encoders based on Huffman coding. For example, a fixed-sized block of pre-shaped bits are converted into a variable-sized block of post-shaped bits.

In some cases, certain techniques may be used to compensate for variable rate code. For example, by adding an outer source encoder, the distribution of pulse-amplitude modulation (PAM) amplitude mapping bits can be changed, e.g., by arithmetic encoding or prefix encoding. In another example, a QAM modulator may receive shaping encoded systematic bits as amplitude information and parity bits as sign information. The parity bits may be evenly distributed. The systematic bits are pre-encoded by a shaping encoder before being mapped to QAM amplitudes.

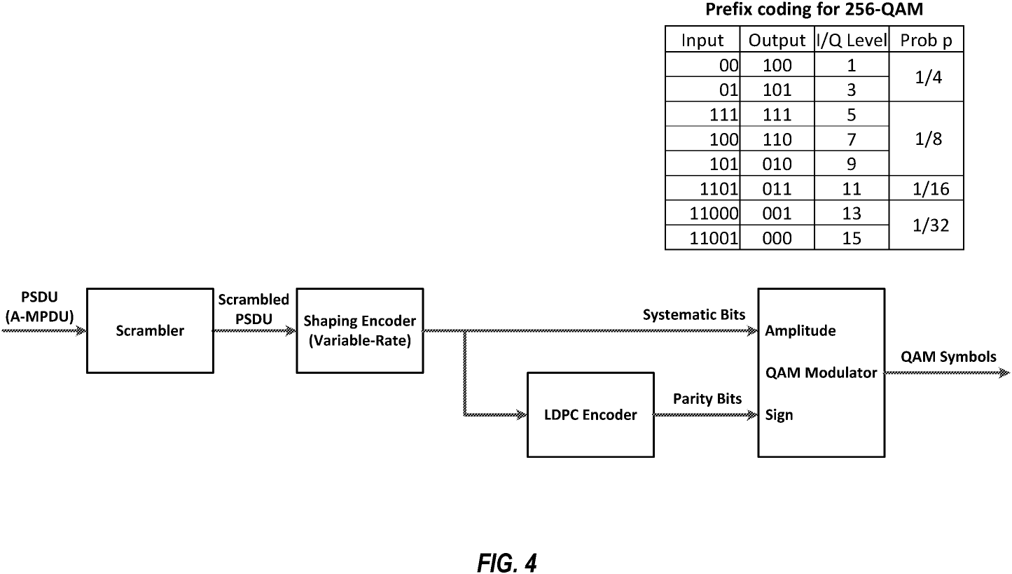

An example of probabilistic shaping encoding is illustrated in FIG. 4. As shown, physical layer convergence procedure (PLCP) service data unit (PSDU) enters a scrambler and is output as scrambled PSDU, which is provided to the shaping encoder. The shaping encoder outputs the systematic bits to the QAM modulator. A low-density parity-check (LDPC) encoder provides parity bits to the QAM modulator. The QAM modulator outputs QAM symbols, which are transmitted in the transport blocks from the transmitter to the receiver.

When the shaping encoder maps a variable number of input bits to a fixed number of output bits, as shown in FIG. 4, the number of transmitted bits is different from the transport block (TB) size (TBS) scheduled by the network entity. The TBS may have an actual size that depends on the specific bits in the payload. As noted above, the mapping may require padding (e.g., adding nominal bits) or truncating (e.g., removing excessive bits), leading to inefficient transmission.

For example, in downlink transmissions, a network entity, at the scheduling instance, often does not know the length of the payload after the shaping encoder in order to issue a physical downlink shared channel (PDSCH) grant accordingly. For uplink transmissions, the network entity may not be aware of the payload size. As such, the network entity may not know the length of the payload after the shaping encoder. For such reasons, a predetermined size (bits length) of the payload has been used after the shaping encoder based on the original payload size.

As noted above, if the actual payload length after the shaping encoder is less than the predetermined size, the encoder output would be padded to match the specified length (causing loss in efficiency). If the actual payload length after the shaping encoder exceeds the predetermined size, then the actual encoder output is truncated (by not sending final output bits, which may result in payload error). Therefore, in the existing practices, a single determined size may result in a larger overhead than needed or a higher packet loss due to truncation than desired.

Certain aspects of the present disclosure provide techniques that may help solve such dilemma by using actual TBS for the shaping encoder output bits (e.g., without padding or truncation).

In addition, with pre-determined TB size after shaping encoder, when a TB is segmented into multiple code blocks (CB), if the receiver encounters decoding error, the error in one CB can propagate to another CB. As further discussed below, Certain aspects of may help address CB level or CB group (CBG) level shaping encoding to avoid such error propagation.

### Example Probabilistic Shaping with Indication of Actual Transport Block Sizes (TBSs)

According to aspects of the present disclosure, a transmitter (e.g., a UE or a network entity) may encode a payload size of bits with a shaping encoder to obtain a transport block (TB) having an actual TB size (TBS).

For example, instead of using one pre-determined actual TB size based on an original (or, nominal) payload size, multiple actual TBSs can be used for a given nominal TBS to improve the shaping encoder efficiency as well as to reduce the event of truncation for the payload failure. The multiple actual payload sizes (after the shaping encoder) may also be aligned with the current TBS.

In some cases, the transmitter indicates the actual TB size to the receiver while the downlink or uplink grant signals the nominal TBS. The indication may be sent, where applicable, on DCI or UCI, a DMRS sequence, a GI sequence, among the like, after the PDSCH/PUSCH encoding.

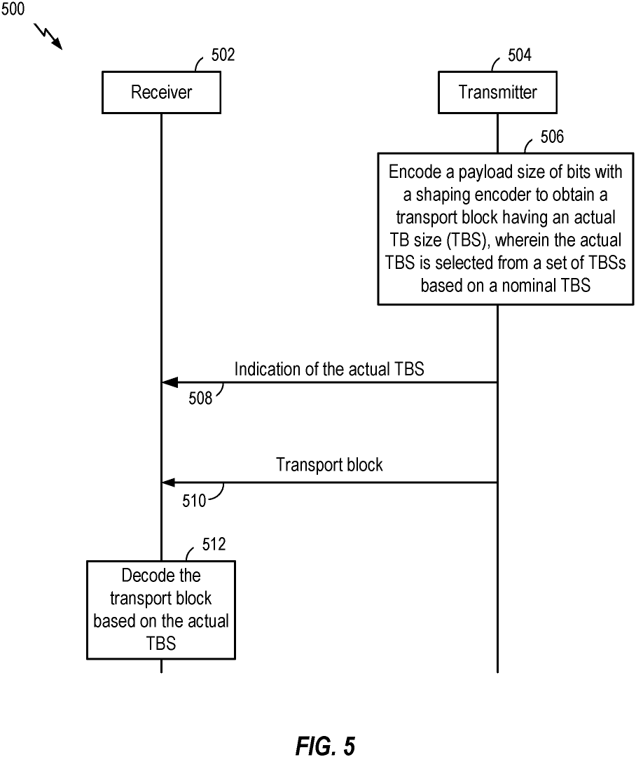

FIG. 5 depicts a call flow diagram between a receiver 502 and a transmitter 504, in accordance with certain aspects of the present disclosure. In some cases, the transmitter may be a UE and the receiver a network entity, such as a gNB (receiving uplink transmissions). In other cases, transmitter may be a network entity and the receiver may be a UE (receiving downlink transmissions).

As shown, the transmitter may, at 506, encode a payload size of bits with a shaping encoder (e.g., for probabilistic shaping) to obtain a TB with an actual TBS. The actual TBS may be selected from a set of TBSs based on a nominal TBS.

At 508, the transmitter transmits an indication of the actual TBS to the receiver. For example, the indication may be sent on piggyback DCI when the transmitter is a network entity, or UCI when the transmitter is a UE. In some cases, the indication may be sent on a demodulation reference signal (DMRS) sequence. In some cases, the indication may be sent via a guard interval (GI) sequence.

At 510, the transmitter transmits one or more TBs to the receiver. The transmitter may use a shaping encoder, such as the shaping encoder described above with reference to FIG. 4.

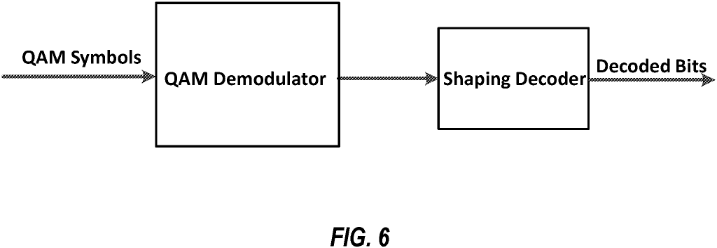

At 512, the receiver decodes the one or more TBs based on the actual TBS. The receiver may use a shaping decoder, such as the shaping decoder described with reference to FIG. 6 below.

An example of shaping decoding is illustrated in FIG. 6. As shown, the received QAM symbols enters the QAM demodulator. The output signals are then decoded by a shaping decoder based on the actual TBS.

In some cases, the UE may skip decoding a transport block in an initial transmission if the effective channel code rate is higher than 0.95, where the effective channel code rate may be defined as the number of downlink information bits (including CRC bits) divided by the number of physical channel bits on PDSCH. The effective code rate may be determined with respect to the actual payload after shaping encoding. In some cases, alternatively, the effective code rate may be defined with respect to the nominal payload before shaping encoding.

According to aspects of the present disclosure, the shaping encoding as described in FIGS. 4-6 may include code block (CB) level encoding.

For example, to avoid error propagation across CBs, instead of performing shaping encoding across the entire nominal TB, shaping encoding is performed on CB level only. Based on the downlink or uplink grant (e.g., when the transmitter is a UE or a network entity respectively), the transmitter may determine the nominal TB size and perform CB segmentation. Thereafter, the transmitter may perform shaping encoding per CB. When multiple shaping encoder output sizes are enabled based on actual TBs as discussed above, the transmitter may indicate each actual CB size after shaping encoder.

In some cases, the transmitter may indicate each actual CB size (e.g., after processing or encoding with the shaping encoder) to the receiver. The actual CB size may be sent to the receiver via piggyback DCI when the transmitter is a network entity or UCI when the transmitter is a UE sending uplink transmissions to the transmitter. In some cases, the actual CB size may be sent to the receiver via DMRS sequences or GI sequences. In cases when the nominal TB includes multiple CBs (e.g., of different segmented sizes), the transmitter indicates the actual sizes of each CB.

According to aspects of the present disclosure, in addition to CB level encoding, the shaping encoding may also be performed on a CB group (CBG) level. For example, to reduce the overhead associated indication of each CB size, CBG level shaping encoding may be implemented, such as when the receiver is configured with CBG level feedback. For example, in addition to or in place of TB level feedback, the transmitter may configure the receiver with CBG level feedback.

When configured, the transmitter may determine the number of CBs per CBG based on nominal TBS and perform CBG level shaping encoding. As such, the transmitter may indicate the actual size of each CBG or TB (instead of each CB) to the receiver, thus reducing transmission overhead. The actual CBG size or TBS may be sent to the receiver via piggyback DCI when the transmitter is a network entity or UCI when the transmitter is a UE sending uplink transmissions to the transmitter. The actual CBG size may also be sent to the receiver via DMRS sequences or GI sequences.

Example aspects of methods and devices are further described below.

### Example Methods

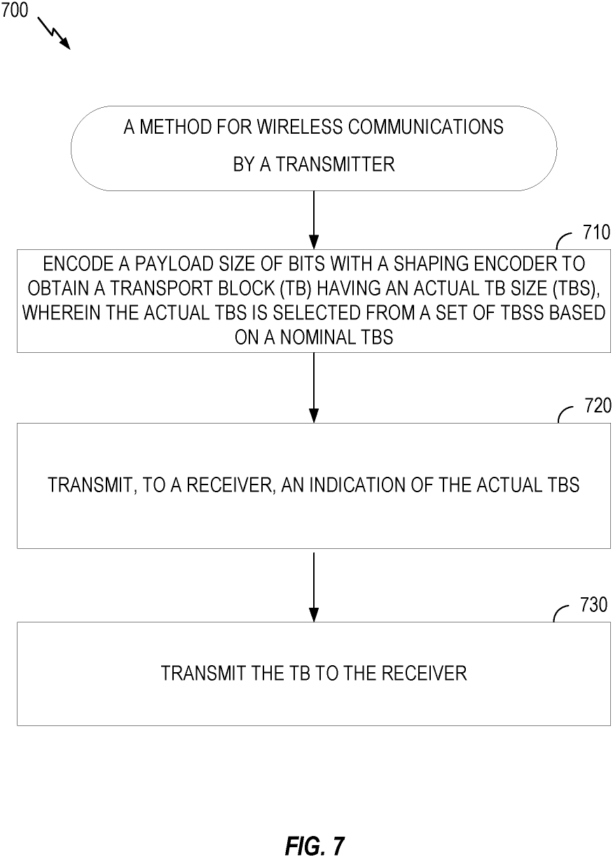

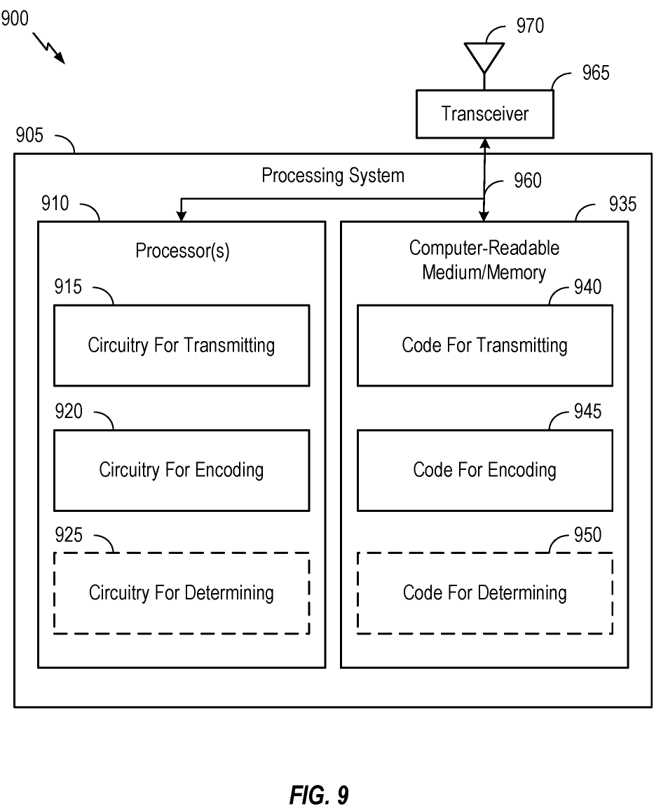

FIG. 7 shows an example of a method 700 for indicating actual TBS for shaping encoding according to aspects of the present disclosure. In some aspects, a transmitter, such as the base station 102 or the UE 104 of FIGS. 1 and 2, or processing system 905 of FIG. 9, may perform the method 700.

At operation 710, the transmitter encodes a payload size of bits with a shaping encoder to obtain a transport block (TB) having an actual TB size (TBS). The actual TBS is selected from a set of TBSs based on a normal TBS. In some cases, the operations of this step refer to, or may be performed by, the circuitry for encoding as described with reference to FIG. 9.

At operation 720, the transmitter transmits an indication of the actual TBS to a receiver. In some cases, the operations of this step refer to, or may be performed by, the circuitry for transmitting as described with reference to FIG. 9.

At operation 730, the transmitter transmits the TB to the receiver. In some cases, the operations of this step refer to, or may be performed by, the circuitry for transmitting as described with reference to FIG. 9.

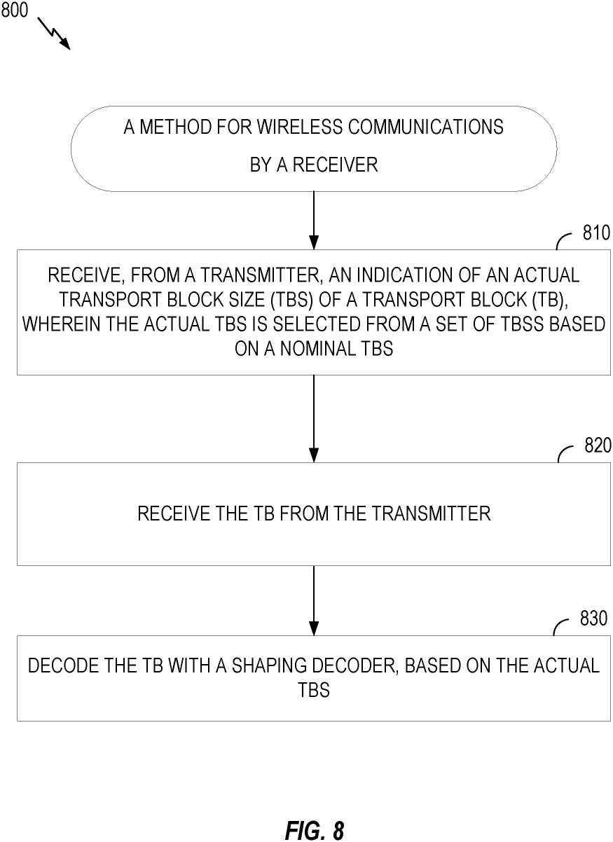

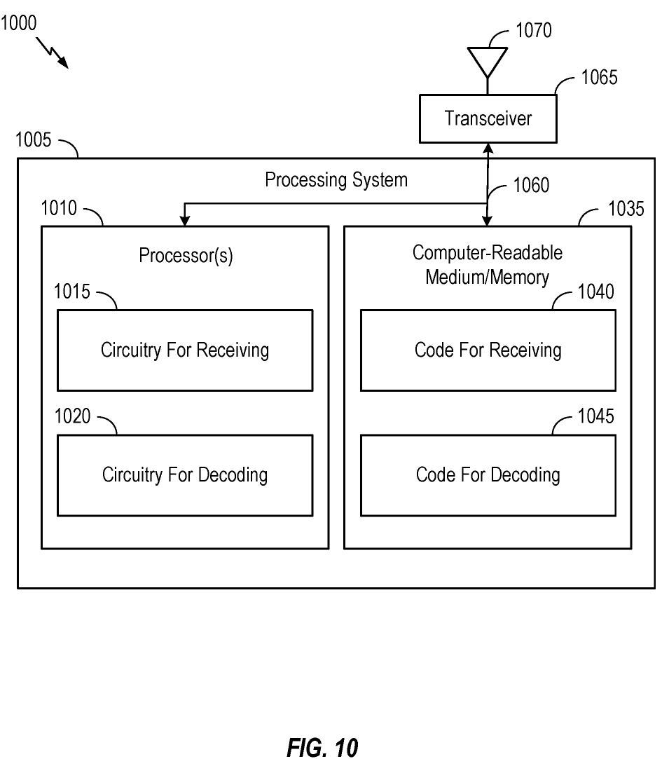

FIG. 8 shows an example of a method 800 for receiving actual TBS for shaping decoding according to aspects of the present disclosure. In some aspects, a receiver, such as the UE 104 (e.g., when the transmitter is a base station) or the base station 102 (e.g., when the transmitter is a UE) of FIGS. 1 and 2, or processing system 1005 of FIG. 10, may perform the method 800. The method 800 may be complementary to the method 700 as discussed above.

At operation 810, the receiver receives, from a transmitter, an indication of an actual TBS of a TB. The actual TBS is selected from a set of TBSs based on a nominal TBS. In some cases, the operations of this step refer to, or may be performed by, the circuitry for receiving as described with reference to FIG. 10.

At operation 820, the receiver receives the TB from the transmitter. In some cases, the operations of this step refer to, or may be performed by, the circuitry for receiving as described with reference to FIG. 10.

At operation 830, the receiver decodes the TB with a shaping encoder based on the actual TBS. In some cases, the operations of this step refer to, or may be performed by, the circuitry for decoding as described with reference to FIG. 10.

In aspects, the transmitter may perform modulation, and the receiver may perform demodulation, based on the payload size of bits corresponding to the actual TBS.

In aspects, encoding the payload size of bits with the shaping encoder may include performing probabilistic shaping.

In aspects, when the transmitter includes a network entity, the transmitter transmits to the receiver an indication of the nominal TBS. In some cases, the indication of the actual TBS is transmitted with DCI.

In aspects, when the transmitter includes a UE, the indication of the actual TBS is transmitted with UCI. In some cases, the transmitter determines an effective code rate based on the actual TBS or the nominal TBS, or both. In some cases, the transmitter determines an effective code rate based on a number of downlink information bits divided by a number of physical channel bits associated with the payload size of bits.

In aspects, the transmitter may transmit the indication of the actual TBS via a DMRS sequence or a GI sequence.

In aspects, the transmitter encodes PDSCH or PUSCH based on the payload size of bits corresponding to the actual TBS.

In aspects, the transmitter performs CB segmentation based on the nominal TBS; and encodes the payload size of bits with the shaping encoder to obtain the TB having the actual TBS. The actual TBS may include a number of bits corresponding to each CB. In some cases, the transmitter performs probabilistic shaping encoding on the number of bits for each CB. In some cases, the transmitter transmits, to the receiver, an indication of an actual size of each CB. For example, the transmitter may transmit the indication of the actual size of each CB via DCI when the transmitter is a network entity, or via UCI when the transmitter is a UE. In some cases, the transmitter may transmit the indication of the actual size of each CB via a DMRS sequence or a GI sequence.

In some cases, the transmitter transmits signaling to configure the receiver to provide feedback based on a group of CBs (CBG). The receiver determines a number of CBs for the CBG based on the nominal TBS. The transmitter may receive, from the receiver, a feedback of the CBG. For example, the transmitter may encode the payload size of bits with the shaping encoder by performing probabilistic shaping encoding on a number of bits corresponding to the CBG or the actual TBS. In some cases, the transmitter may transmit an indication of an actual size of the CBG to the receiver. The indication of the actual size of the CBG may be transmitted via downlink control information (DCI) when the transmitter is a network entity or via uplink control information (UCI when the transmitter is a UE. The indication may also be transmitted via a DMRS sequence or a GI sequence.

### Example Wireless Communication Devices

FIG. 9 depicts an example communications device 900 that includes various components operable, configured, or adapted to perform operations for the techniques disclosed herein, such as the operations depicted and described with respect to FIG. 7. In some examples, communication device may be a transmitter as described (e.g., a UE or gNB), for example with respect to FIGS. 1 and 2.

Communications device 900 includes a processing system 905 coupled to a transceiver 965 (e.g., a transmitter and/or a receiver). Transceiver 965 is configured to transmit (or send) and receive signals for the communications device 900 via an antenna 970, such as the various signals as described herein. In some aspects, transceiver 965 is an example of, or includes aspects of, the corresponding element described with reference to FIG. 7.

Processing system 905 may be configured to perform processing functions for communications device 900, including processing signals received and/or to be transmitted by communications device 900. In some aspects, the one or more processors 910 are examples of, or include aspects of, the corresponding elements described with reference to FIG. 7.

Processing system 905 includes one or more processors 910 coupled to a computer-readable medium/memory 935 via a bus 960. In certain aspects, computer-readable medium/memory 935 is configured to store instructions (e.g., computer-executable code) that when executed by the one or more processors 910, cause the one or more processors 910 to perform the operations illustrated in FIG. 7, or other operations for performing the various techniques discussed herein. In some aspects, computer-readable medium/memory 935 is an example of, or includes aspects of, the corresponding element described with reference to FIG. 7.

In one aspect, computer-readable medium/memory 935 includes the code for transmitting 940, the code for encoding 945, and the code for determining 950, which enable the transmitter to perform the operation 700 of FIG. 7.

Examples of a computer-readable medium/memory 935 include random access memory (RAM), read-only memory (ROM), solid state memory, a hard drive, a hard disk drive, etc. In some examples, computer-readable medium/memory 935 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

In one aspect, one or more processors 910 includes the circuitry for transmitting 915, the circuitry for encoding 920, and the circuitry for determining 925, which enable the transmitter to perform the operation 700 of FIG. 7.

Various components of communications device 900 may provide means for performing the methods described herein, including with respect to FIG. 7.

In some examples, means for transmitting or sending (or means for outputting for transmission) may include, for example, the transceivers 232 and/or antenna(s) 234 of the base station 102, or the transceivers 254 and/or antenna(s) 252 of the user equipment 104 illustrated in FIG. 2 and/or transceiver 965 and antenna 970 of the communication device in FIG. 9.

In some examples, means for receiving (or means for obtaining) may include the transceivers 232 and/or antenna(s) 234 of the base station 102 or the the transceivers 254 and/or antenna(s) 252 of the user equipment 104 illustrated in FIG. 2 and/or transceiver 965 and antenna 970 of the communication device in FIG. 9.

In some examples, means for encoding or determining may include various processing system 905 components, such as: the one or more processors 910 in FIG. 9, or aspects of the base station 102 or the UE 104 depicted in FIG. 2, including receive processor 237 or 258, transmit processor 220 or 264, TX MIMO processor 230 or 266, and/or controller/processor 240 or 218.

Notably, FIG. 9 is just use example, and many other examples and configurations of communication device are possible.

FIG. 10 depicts an example communications device 1000 that includes various components operable, configured, or adapted to perform operations for the techniques disclosed herein, such as the operations depicted and described with respect to FIG. 8. In some examples, communication device may be a receiver, such as the user equipment 104 when the transmitter is a base station, or the base station 102 when the transmitter is a UE, as described, for example with respect to FIGS. 1 and 2.

Communications device 1000 includes a processing system 1005 coupled to a transceiver 1065 (e.g., a transmitter and/or a receiver). Transceiver 1065 is configured to transmit (or send) and receive signals for the communications device 1000 via an antenna 1070, such as the various signals as described herein. A transceiver 1065 may communicate bi-directionally, via antennas 1070, wired, or wireless links as described above. For example, the transceiver 1065 may represent a wireless transceiver 1065 and may communicate bi-directionally with another wireless transceiver 1065. The transceiver 1065 may also include or be connected to a modem to modulate the packets and provide the modulated packets to for transmission, and to demodulate received packets. In some examples, transceiver 1065 may be tuned to operate at specified frequencies. For example, a modem can configure the transceiver 1065 to operate at a specified frequency and power level based on the communication protocol used by the modem.

Processing system 1005 may be configured to perform processing functions for communications device 1000, including processing signals received and/or to be transmitted by communications device 1000. Processing system 1005 includes one or more processors 1010 coupled to a computer-readable medium/memory 1035 via a bus 1060.

In some examples, one or more processors 1010 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1010 are configured to operate a memory array using a memory controller. In other cases, a memory controller is integrated into the one or more processors 1010. In some cases, the one or more processors 1010 are configured to execute computer-readable instructions stored in a memory to perform various functions. In some aspects, one or more processors 1010 include special purpose components for modem processing, baseband processing, digital signal processing, or transmission processing.

In certain aspects, computer-readable medium/memory 1035 is configured to store instructions (e.g., computer-executable code) that when executed by the one or more processors 1010, cause the one or more processors 1010 to perform the operations illustrated in FIG. 8, or other operations for performing the various techniques discussed herein.

In one aspect, computer-readable medium/memory 1035 includes the code for receiving 1040 and the code for decoding 1045, which enable the UE to perform the operation 800 of FIG. 8.

Examples of a computer-readable medium/memory 1035 include random access memory (RAM), read-only memory (ROM), solid state memory, a hard drive, a hard disk drive, etc. In some examples, computer-readable medium/memory 1035 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

In one aspect, one or more processors 1010 includes the circuitry for receiving 1015 and the circuitry for decoding 1020, which enable the UE to perform the operation 800 of FIG. 8.

Various components of communications device 1000 may provide means for performing the methods described herein, including with respect to FIG. 8.

In some examples, means for communicating may include the transceivers 254 and/or antenna(s) 252 of the user equipment 104, or the transceivers 232 and/or antenna(s) 234 of the base station 102 illustrated in FIG. 2 and/or transceiver 1065 and antenna 1070 of the communication device in FIG. 10.

In some examples, means for receiving may include the transceivers 254 and/or antenna(s) 252 of the user equipment 104 or the transceivers 232 and/or antenna(s) 234 of the base station 102 illustrated in FIG. 2 and/or transceiver 1065 and antenna 1070 of the communication device in FIG. 10.

In some examples, means for decoding or processing may include various processing system 1005 components, such as: the one or more processors 1010 in FIG. 10, or aspects of the user equipment 104 or the base station 102 depicted in FIG. 2, including receive processor 258 or 237, transmit processor 264 or 220, TX MIMO processor 266 or 230, and/or controller/processor 218 or 240.

Notably, FIG. 10 is just use example, and many other examples and configurations of communication device are possible.

### Example Clauses

Implementation examples are described in the following numbered clauses:

Clause 1: A method for wireless communications by a transmitter, comprising: encoding a payload size of bits with a shaping encoder to obtain a transport block (TB) having an actual TB size (TBS), wherein the actual TBS is selected from a set of TBSs based on a nominal TBS; transmitting, to a receiver, an indication of the actual TBS; and transmitting the TB to the receiver.

Clause 2: The method of Clause 1, further comprising: performing modulation based on the payload size of bits corresponding to the actual TBS.

Clause 3: The method of Clause 1 or 2, wherein encoding the payload size of bits with the shaping encoder comprises performing probabilistic shaping.

Clause 4: The method of any one of Clauses 1 to 3, wherein: the transmitter comprises a network entity; and the method further comprises transmitting, to the receiver, an indication of the nominal TBS.

Clause 5: The method of any one of Clauses 1 to 4, wherein: the transmitter comprises a network entity; and the indication of the actual TBS is transmitted with downlink control information (DCI).

Clause 6: The method of any one of Clauses 1 to 4, wherein: the transmitter comprises user equipment (UE); and the indication of the actual TBS is transmitted with uplink control information (UCI).

Clause 7: The method of Clause 6, further comprising: determining an effective code rate based on the actual TBS or the nominal TBS.

Clause 8: The method of Clause 6, further comprising: determining an effective code rate based on a number of downlink information bits divided by a number of physical channel bits associated with the payload size of bits.

Clause 9: The method of Clause 1, wherein transmitting the indication of the actual TBS comprises: transmitting the indication of the actual TBS via a demodulation reference signal (DMRS) sequence or a guard interval (GI) sequence.

Clause 10: The method of Clause 1, further comprising: encoding physical downlink shared channel (PDSCH) or physical uplink shared channel (PUSCH) based on the payload size of bits corresponding to the actual TBS.

Clause 11: The method of Clause 1, further comprising: performing code block (CB) segmentation based on the nominal TBS; and encoding the payload size of bits with the shaping encoder to obtain the TB having the actual TBS, wherein the actual TBS includes a number of bits corresponding to each CB.

Clause 12: The method of Clause 11, further comprising: performing probabilistic shaping encoding on the number of bits for each CB.

Clause 13: The method of Clause 11, further comprising: transmitting, to the receiver, an indication of an actual size of each CB.

Clause 14: The method of Clause 13, wherein transmitting the indication of the actual size of each CB comprises at least one of: transmitting the indication of the actual size of each CB via: downlink control information (DCI) when the transmitter is a network entity, or uplink control information (UCI) when the transmitter is a UE; or transmitting the indication of the actual size of each CB via a demodulation reference signal (DMRS) sequence or a guard interval (GI) sequence.

Clause 15: The method of Clause 11, further comprising: transmitting signaling to configure the receiver to provide feedback based on a group of CBs (CBG), wherein the receiver determines a number of CBs for the CBG based on the nominal TBS; and receiving, from the receiver, a feedback of the CBG.

Clause 16: The method of Clause 15, wherein encoding the payload size of bits with the shaping encoder comprises: performing probabilistic shaping encoding on a number of bits corresponding to the CBG or the actual TBS.

Clause 17: The method of Clause 16, further comprising: transmitting, to the receiver, an indication of an actual size of the CBG.

Clause 18: The method of Clause 17, wherein transmitting the indication of the actual size of the CBG comprises at least one of: transmitting the indication of the actual size of the CBG via: downlink control information (DCI) when the transmitter is a network entity, or uplink control information (UCI) when the transmitter is a UE; or transmitting the indication of the actual size of each CB via a demodulation reference signal (DMRS) sequence or a guard interval (GI) sequence.

Clause 19: A method for wireless communications by a receiver, comprising: receiving, from a transmitter, an indication of an actual transport block size (TBS) of a transport block (TB), wherein the actual TBS is selected from a set of TBSs based on a nominal TBS; receiving the TB from the transmitter; and decoding the TB with a shaping decoder, based on the actual TBS.

Clause 20: The method of Clause 19, further comprising: performing demodulation based on the payload size of bits corresponding to the actual TBS.

Clause 21: The method of Clause 19, wherein: the transmitter comprises a network entity; and the method further comprises receiving, from the transmitter, an indication of the nominal TBS.

Clause 22: The method of Clause 19, wherein: the transmitter comprises a network entity; and the indication of the actual TBS is transmitted with downlink control information (DCI).

Clause 23: The method of Clause 19, wherein: the transmitter comprises user equipment (UE); and the indication of the actual TBS is transmitted with uplink control information (UCI).

Clause 24: The method of Clause 19, wherein receiving the indication of the actual TBS comprises: receiving the indication of the actual TBS via a demodulation reference signal (DMRS) sequence or a guard interval (GI) sequence.

Clause 25: The method of Clause 19, further comprising: receiving, from the transmitter, the indication of the actual TBS, wherein the actual TBS includes a number of bits corresponding to each code block (CB) that is segmented based on the nominal TBS.

Clause 26: The method of Clause 25, further comprising: performing probabilistic shaping decoding on the number of bits for each CB.

Clause 27: The method of Clause 25, further comprising: receiving, from the transmitter, an indication of an actual size of each CB.

Clause 28: The method of Clause 25, further comprising: receiving signaling to configure the receiver to provide feedback based on a group of CBs (CBG), and the method further comprising determining a number of CBs for the CBG based on the nominal TBS; and transmitting, to the transmitter, a feedback of the CBG.

Clause 29: A transmitter for wireless communications, comprising: a memory; and a processor coupled with the memory, the processor and the memory configured to: encode a payload size of bits with a shaping encoder to obtain a transport block (TB) having an actual TB size (TBS), wherein the actual TBS is selected from a set of TBSs based on a nominal TBS; transmit, to a receiver, an indication of the actual TBS; and transmit the TB to the receiver.

Clause 30: An apparatus for wireless communications, comprising: means for encoding a payload size of bits with a shaping encoder to obtain a transport block (TB) having an actual TB size (TBS), wherein the actual TBS is selected from a set of TBSs based on a nominal TBS; means for transmitting, to a receiver, an indication of the actual TBS; and means for transmitting the TB to the receiver.

Clause 31: A processing system, comprising: a memory comprising computer-executable instructions; one or more processors configured to execute the computer-executable instructions and cause the processing system to perform a method in accordance with any one of Clauses 1-28.

Clause 32: A processing system, comprising means for performing a method in accordance with any one of Clauses 1-28.

Clause 33: A non-transitory computer-readable medium comprising computer-executable instructions that, when executed by one or more processors of a processing system, cause the processing system to perform a method in accordance with any one of Clauses 1-28.

Clause 34: A computer program product embodied on a computer-readable storage medium comprising code for performing a method in accordance with any one of Clauses 1-28.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152 / AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a- 232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234at, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (µ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology µ, there are 14 symbols/slot and 2 µ slots/subframe. The subcarrier spacing and symbol length/duration are a function of the numerology. The subcarrier spacing may be equal to 2^{µ} _{X} 15 kHz, where µ is the numerology 0 to 5. As such, the numerology µ = 0 has a subcarrier spacing of 15 kHz and the numerology µ = 5 has a subcarrier spacing of 480 kHz. The symbol length/duration is inversely related to the subcarrier spacing. FIGS. 3A-3D provide an example of slot configuration 0 with 14 symbols per slot and numerology µ = 2 with 4 slots per subframe. The slot duration is 0.25 ms, the subcarrier spacing is 60 kHz, and the symbol duration is approximately 16.67 µs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of [SHORT INVENTION DESCRIPTION] in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a transmitter, comprising:
encoding a payload size of bits with a shaping encoder to obtain a transport block (TB) having an actual TB size (TBS), wherein the actual TBS is selected from a set of TBSs based on a nominal TBS;
transmitting, to a receiver, an indication of the actual TBS; and
transmitting the TB to the receiver.

2. The method of claim 1, further comprising:
performing modulation based on the payload size of bits corresponding to the actual TBS.

3. The method of claim 1, wherein encoding the payload size of bits with the shaping encoder comprises performing probabilistic shaping.

4. The method of claim 1, wherein:
the transmitter comprises a network entity; and
the method further comprises transmitting, to the receiver, an indication of the nominal TBS.

5. The method of claim 1, wherein:
the transmitter comprises a network entity; and
the indication of the actual TBS is transmitted with downlink control information (DCI).

6. The method of claim 1, wherein:
the transmitter comprises user equipment (UE); and
the indication of the actual TBS is transmitted with uplink control information (UCI).

7. The method of claim 6, further comprising:
determining an effective code rate based on the actual TBS or the nominal TBS.

8. The method of claim 6, further comprising:
determining an effective code rate based on a number of downlink information bits divided by a number of physical channel bits associated with the payload size of bits.

9. The method of claim 1, wherein transmitting the indication of the actual TBS comprises:
transmitting the indication of the actual TBS via a demodulation reference signal (DMRS) sequence or a guard interval (GI) sequence.

10. The method of claim 1, further comprising:
encoding physical downlink shared channel (PDSCH) or physical uplink shared channel (PUSCH) based on the payload size of bits corresponding to the actual TBS.

11. The method of claim 1, further comprising:
performing code block (CB) segmentation based on the nominal TBS; and
encoding the payload size of bits with the shaping encoder to obtain the TB having the actual TBS, wherein the actual TBS includes a number of bits corresponding to each CB.

12. The method of claim 11, further comprising:
performing probabilistic shaping encoding on the number of bits for each CB.

13. The method of claim 11, further comprising:
transmitting, to the receiver, an indication of an actual size of each CB.

14. The method of claim 13, wherein transmitting the indication of the actual size of each CB comprises at least one of:
transmitting the indication of the actual size of each CB via:
downlink control information (DCI) when the transmitter is a network entity, or
uplink control information (UCI) when the transmitter is a UE; or
transmitting the indication of the actual size of each CB via a demodulation reference signal (DMRS) sequence or a guard interval (GI) sequence.

15. The method of claim 11, further comprising:
transmitting signaling to configure the receiver to provide feedback based on a group of CBs (CBG), wherein the receiver determines a number of CBs for the CBG based on the nominal TBS; and
receiving, from the receiver, a feedback of the CBG.

16. The method of claim 15, wherein encoding the payload size of bits with the shaping encoder comprises:
performing probabilistic shaping encoding on a number of bits corresponding to the CBG or the actual TBS.

17. The method of claim 16, further comprising:
transmitting, to the receiver, an indication of an actual size of the CBG.

18. The method of claim 17, wherein transmitting the indication of the actual size of the CBG comprises at least one of:
transmitting the indication of the actual size of the CBG via:
downlink control information (DCI) when the transmitter is a network entity, or
uplink control information (UCI) when the transmitter is a UE; or
transmitting the indication of the actual size of each CB via a demodulation reference signal (DMRS) sequence or a guard interval (GI) sequence.

19. A method for wireless communications by a receiver, comprising:
receiving, from a transmitter, an indication of an actual transport block size (TBS) of a transport block (TB), wherein the actual TBS is selected from a set of TBSs based on a nominal TBS;
receiving the TB from the transmitter; and
decoding the TB with a shaping decoder, based on the actual TBS.

20. The method of claim 19, further comprising performing demodulation based on the actual TBS.

21. The method of claim 19, wherein:
the transmitter comprises a network entity; and
the method further comprises receiving, from the transmitter, an indication of the nominal TBS.

22. The method of claim 19, wherein:
the transmitter comprises a network entity; and
the indication of the actual TBS is transmitted with downlink control information (DCI).

23. The method of claim 19, wherein:
the transmitter comprises user equipment (UE); and
the indication of the actual TBS is transmitted with uplink control information (UCI).

24. The method of claim 19, wherein receiving the indication of the actual TBS comprises:
receiving the indication of the actual TBS via a demodulation reference signal (DMRS) sequence or a guard interval (GI) sequence.

25. The method of claim 19, further comprising:
receiving, from the transmitter, the indication of the actual TBS, wherein the actual TBS includes a number of bits corresponding to each code block (CB) that is segmented based on the nominal TBS.

26. The method of claim 25, further comprising:
performing probabilistic shaping decoding on the number of bits for each CB.

27. The method of claim 25, further comprising:
receiving, from the transmitter, an indication of an actual size of each CB.

28. The method of claim 25, further comprising:
receiving signaling to configure the receiver to provide feedback based on a group of CBs (CBG), and the method further comprising determining a number of CBs for the CBG based on the nominal TBS; and
transmitting, to the transmitter, a feedback of the CBG.

29. A transmitter for wireless communications, comprising:
a memory; and
a processor coupled with the memory, the processor and the memory configured to:
encode a payload size of bits with a shaping encoder to obtain a transport block (TB) having an actual TB size (TBS), wherein the actual TBS is selected from a set of TBSs based on a nominal TBS;
transmit, to a receiver, an indication of the actual TBS; and
transmit the TB to the receiver.

30. An apparatus for wireless communications, comprising:
means for encoding a payload size of bits with a shaping encoder to obtain a transport block (TB) having an actual TB size (TBS), wherein the actual TBS is selected from a set of TBSs based on a nominal TBS;
means for transmitting, to a receiver, an indication of the actual TBS; and
means for transmitting the TB to the receiver.
